(19) United States
(12) Patent Application Publication
(10) Pub. No.: US 2007/0042630 A1
(43) Pub. Date: Feb. 22, 2007

(54) CONNECTOR HOUSING

(76) Inventors: Kai Huning, Wittibreut (DE); Rainer Trager, Pleiskirchen (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/465,416

(22) Filed: Aug. 17, 2006

(30) Foreign Application Priority Data
Aug. 17, 2005 (DE) 202005012982.8

(51) Int. Cl. H01R 13/627

(52) U.S. Cl. 439/350

(57) ABSTRACT

Connector housing for a plug of an electric plug-in connector with at least one plug-in part capable of insertion of at least one plug-in end in a direction of insertion into a receptacle. At least one latching element is transversally adjustable to the direction of insertion between a lock-in position and a release position. Latching elements serve to lock the plug relative to the receptacle. A release sleeve surrounds a sleeve axis and extends parallel to the direction of insertion and is capable moving, especially in the opposite direction of the direction of insertion, relative to the at least one latching element. The release sleeve actuated to shift the latching element from the lock-in position to the release position. The release sleeve exhibits a gripping area preferably surrounding the sleeve axis with a shell surface radially expanding in the direction of one axial end.

### CROSS-REFERENCES TO RELATED APPLICATIONS

The present application claims International Priority under 35 U.S.C. §119 to co-pending German Patent Application No. 20 2005 012 982.8 filed Aug. 17, 2005, entitled “Steckergehaüse”, the entire contents and disclosure of which is hereby incorporated by reference in its entirety.

### TECHNICAL FIELD

Embodiments of the present invention relate to the field of connectors. More particularly, various embodiments relate to connector housings used for the manufacture of plug-in connectors requiring that the plug be secured against removal from a receptacle or socket of the connector.

### BACKGROUND

Connector housings for plug-in connectors designed to secure the plug against removal from a socket or receptacle are often provided with latching elements. In the plug-in position, the latching elements engage in respective recesses of the socket or receptacle of the connector and thus prevent the removal of the plug from the socket.

In the event that a secured connector is to be disconnected intentionally, the latching elements received in the respective recesses of the socket may be moved by a release mechanism, such as a sleeve that extends over an axial length of the secured connector. The release sleeve moves in a direction that is opposite to the direction of insertion relative to the latching elements. When the latching elements penetrate recesses in the release sleeve, this movement can effect a shift of the latching elements in the direction of the sleeve axis. Furthermore, the desired detachment of the connector can be effected by removal of the plug from the socket in the further course of the movement of the release sleeve longitudinally along the sleeve axis.

To counteract the slipping of the fingers from the sleeve and to enable easy handling during the movement of the release sleeve, a sleeve surface with a profile formed by trough-like depressions, at least in some areas, may be provided. Unfortunately, the profiled area of the release sleeve extends over a considerable axial length of the connector and complicates the use of the connector housings of the above-described type in narrow spaces.

Moreover, as described, the release sleeve would move along the axial length of the secured connector to switch the latching elements from a lock-in position to a release position and would thus require even more axial length to allow free movement of the release sleeve. Unfortunately, a connector housing for a plug of an electric plug-in connector of the above-described type may not currently be used in confined and/or narrow spaces due to the required axial length.

### SUMMARY OF INVENTION

Embodiments of the invention relate to a connector housing for a plug of an electric plug-in connector. The connector housing includes at least one plug-in part with at least one plug-in end capable of insertion into a receptacle along a direction of insertion. At least one latching element of the connector housing is transversally adjustable between a lock-in position and a release position along the direction of insertion. The latching element serves to lock the plug relative to the receptacle and a release sleeve, which surrounds a sleeve axis running approximately parallel to the direction of insertion. The release sleeve extends parallel to the direction of insertion and is capable of being moved especially in the opposite direction of the direction of insertion relative to the at least one latching element. The release sleeve is capable of being actuated for the shifting of the latching element from the lock-in position to the release position. According to a feature of one embodiment of the invention, the release sleeve further exhibits a gripping area with a shell surface radially expanding in the direction of one of its axial ends.

Although various embodiments of the invention are illustrated and described herein as embodied in a connection device and/or connector, it is, nevertheless, not intended to be limited to the details shown because various modifications and structural changes may be made therein without departing from the spirit of various embodiments of the invention and remain within the scope and range of equivalents of the claims.

Various embodiments of the invention include a counter bearing area on the release sleeve, which, if necessary, extends only over a small axial length. The counter bearing area forms a suitable contact area for the fingertips during the movement of the release sleeve in the direction parallel to the direction of insertion. Use of the counter bearing area dispenses with the need for a profiled shell surface area extending over a fingertip-wide section of the axial length of the release sleeve. This counter bearing area forming a suitable contact area further facilitates the operation of the connector housings, according to one embodiment of the invention, in narrow spaces.

Moreover, a high plug density is made possible, as a slight radial expansion of the shell surface of the gripping area is sufficient to provide the desired contact area so that the radial expansion of the shell surface of the gripping area does not produce an appreciable reduction of the possible plug density. Without the further development, according to one embodiment of the invention, the axial length of the release sleeve increases so that the axial force required to undo the connection can be produced with several fingers contacting the release sleeve.

As previously explained above, in the context of connector housings, it is particularly advantageous for the release sleeve to be moved in a direction opposite to the direction of insertion in order to move the latching element from the locking position into the release position. This movement is facilitated in the further developed connector housings, according to one embodiment of the invention, if the shell surface of the gripping area expands radially, especially conically, in the direction of its end opposite the plug-in end. A conic expansion has proved to be advantageous because it can be realized without sharp corners and edges in order to reduce the risk of damage and injuries in the gripping area.

Within the context of various embodiments of the invention, the outer shell surface of the gripping area exhibits, at least in some sections, the shape of a conical frustum shell of a cone. The conical shape simultaneously avoids an excessive radial expansion of the release sleeve without reducing the packing density. In various embodiments, the conical frustum shell of the cone includes an opening angle in the range of 15 to 80°, particularly 25 to 55°, and especially preferred 30 to 45°. Various embodiments exhibit a ratio of the largest outer diameter D of the gripping area to the smallest outer diameter d of the gripping area in the range of about 1.1 or more, specifically about 1.15 or more. Moreover, an excessive radial expansion of the gripping area is attained while simultaneously ensuring a contact area in the gripping area of the sleeve that still sufficiently facilitates the movement when the ratio D/d is about 1.5 or less, specifically about 1.25 or less.

In one embodiment, at the end opposite its plug-in end, the gripping area advantageously transitions into a frontal sleeve area that preferably extends approximately vertically to the sleeve axis. If necessary, in conjunction with further components, this frontal sleeve area may form a stop mechanism limiting the axial movement of the sleeve relative to the latching element. In one embodiment, a rounded transition area between the gripping area and the frontal area is provided to avoid damage and injuries.

In one embodiment, the connector housing exhibits at least one recess provided in the shell area of the release sleeve and dimensioned to receive at least one latching element in the lock-in position. The insertion of a respective connector housing into a suitable receptacle can then be facilitated, just like the movement of the latching element from the lock-in position to the release position, if the latching element exhibits a sliding area rising in a ramp-like manner in a direction opposite to the direction of insertion relative to the sleeve axis, with said sliding area advantageously transitioning into a frontal area of the latching element and with said frontal area running approximately vertically to the sleeve axis.

In one embodiment, a desired pull-out protection may be attained in a particularly reliable manner if at least one pre-tensioning mechanism is provided which pushes at least one latching element into the lock-in position. This pre-tensioning mechanism may be designed in the manner of a leaf spring if the plug-in part exhibits an internal sleeve that is at least partially accommodated in the release sleeve, with at least one latching element being formed in one piece on said internal sleeve.

### BRIEF DECRIPTION OF THE DRAWINGS

The present invention will be described by way of exemplary embodiments, but not limitations, illustrated in the accompanying drawings in which like references denote similar elements, and in which:

FIG. 1a is a perspective view of a connector housing according to various embodiments of the invention;

FIG. 1b is a perspective view of a connector housing according to FIG. 1a in the assembled state; and

FIG. 2 is an axial cross-sectional view of the assembled connector housing according to FIG. 1b.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” indicates that a particular feature, structure, or characteristic described in connection with the embodiment is included in at least one embodiment. The appearances of the phrase “in one embodiment” in various places in the specification do not necessarily all refer to the same embodiment, but it may. The phrase “A/B” means “A or B”. The phrase “A and/or B” means “(A), (B), or (A and B)”. The phrase “at least one of A, B, and C” means “(A), (B), (C), (A and B), (A and C), (B and C) or (A, B and C)”. The phrase “(A) B” means “(A B) or (B)”, that is “A” is optional.

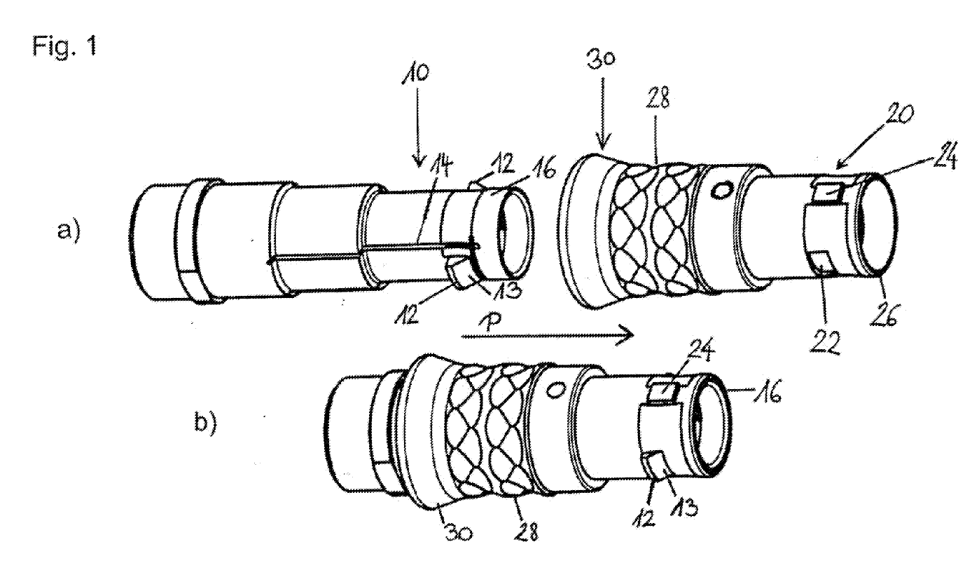

As illustrated in the exploded view according to FIG. 1a, the connector housing, according to one embodiment of the invention, comprises an internal sleeve 10 and a release sleeve 20. The internal sleeve 10 essentially has the design of a circular cylinder shell, with the diameter of the internal sleeve 10 being increased in a stepwise fashion in the direction of the axial end facing away from its plug-in end 16. On the internal sleeve 10, two latching elements 12 are provided that protrude radially to the outside relative to the sleeve axis. Here, the latching elements 12 are formed on the ends of leaf spring-like elements of the internal sleeve 10 with these ends facing the plug-in end 16. These leaf spring-type elements are implemented by approximately U-shaped intersecting lines in the shell surface of the internal sleeve 10 with the connecting leg connecting the two outer legs of the intersecting line 14 facing the plug-in end 16. In this way, the latching elements 12 may be moved, opposite to a pretension force effected by the leaf spring-type structure, in the direction of the sleeve axis radially towards the inside.

In the embodiment of the invention presented in FIG. 1, such a movement of the latching elements 12 is facilitated in the course of an insertion movement of the internal sleeve 10 into the release sleeve 20 and/or of a plug-in sleeve of the connector housing formed by the insertion of the internal sleeve 10 into the release sleeve 20 in the direction of insertion P, in that the latching elements 12 exhibit the sliding areas 13 rising in a ramp-like manner in a direction opposite to the direction of insertion P relative to the sleeve axis.

In its plug-in end, the release sleeve 20 comprises recesses 22, which are penetrated by the latching elements 12 in the assembled stated. Furthermore, in the area of the plug-in end 26, guiding elements 24 are provided, which facilitate the insertion of the connector housing into a socket. Adjoining to the insertion area and in the direction of the axial end opposite the plug-in end 26, there is an essentially circular cylinder shell-shaped area 28 with a trough-like profile, which transitions into a gripping area 30 in the direction of the end opposite the plug-in end 26, the outer shell surface of which expands in the direction of the axial end, opposite the plug-in end 26, of the release sleeve 20.

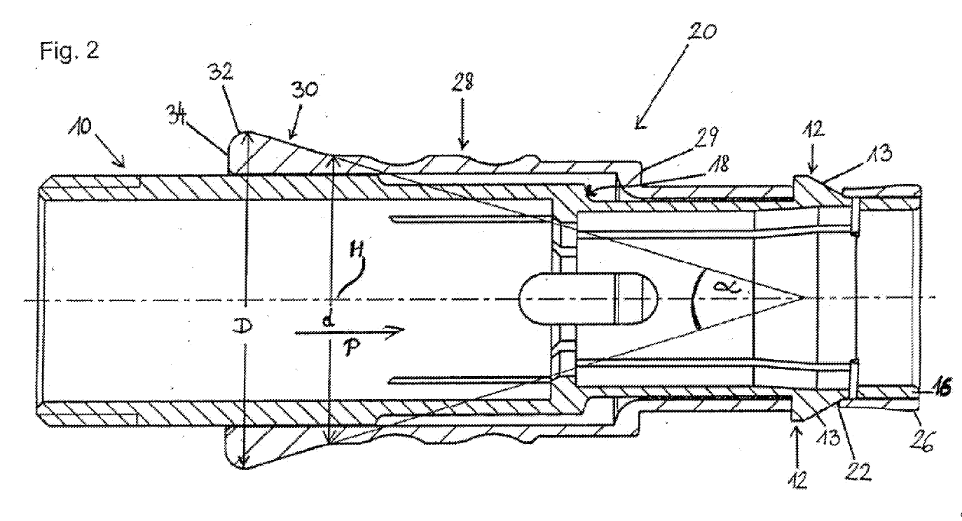

As illustrated in FIG. 2, the outer shell surface of the gripping area 30 of the release sleeve 20 exhibits the shape of a conical frustum of a cone with an opening angle α of about 35° with the outer diameter of the gripping area 30 increasing to a higher value D, starting from a smaller diameter d, in the direction of the end facing away from the plug-in end 26. In this way, the outer shell area of the gripping area 30 forms a contact area favoring the movement of the release sleeve 20 in a direction opposite to the direction of insertion P relative to the latching elements 12. In the direction of the end opposite the plug-in end 26, the gripping area 30 transitions via a rounded transition area 32 into a frontal area 34 extending approximately vertically to the sleeve axis H. In the direction of the plug-in end 26, the circular cylinder shell-shaped area 28 transitions into the insertion area via a recess 29. Together with a corresponding recess 18 of the internal sleeve 10, the recess 29 forms a stop means limiting the axial movement of the release sleeve 20 relative to the latching elements 12 in the direction opposite the direction of insertion P.

As illustrated in FIGS. 1b and 2, the latching elements 12 penetrate the recesses 22 in the shell surface of the release sleeve 20 in the assembled state of the connector housing. In the course of an axial movement of the release sleeve 20 relative to the latching elements 12 in a direction opposite to the direction of insertion P, a front edge of recess 22, facing the plug-in end 26, is brought into a sliding contact with the sliding area 13, which rises in a ramp-like manner, of the latching elements 12 causing the latching elements 12 to be moved radially to the inside in the direction of the sleeve axis H. As soon as the release sleeve 20 is released, it is moved back into the position shown in FIG. 2 due to the pre-tensioning effect of the leaf spring formed by the U-shaped intersecting line 14 (FIG. 1a) and the sliding area 13 abutting the front edge of the recess 22.

Although specific embodiments have been illustrated and described herein, it will be appreciated by those of ordinary skill in the art and others, that a wide variety of alternate and/or equivalent implementations may be substituted for the specific embodiment shown in the described without departing from the scope of the present invention. This application is intended to cover any adaptations or variations of the embodiment discussed herein. Therefore, it is manifested and intended that the invention be limited only by the claims and the equivalents thereof.

What is claimed is:

1. Connector housing for a plug of an electric plug-in connector, comprising:
at least one plug-in part having at least one plug-in end and at least one latching element, the at least one plug-in end configured to insert into a receptacle along a direction of insertion and upon insertion the at least one latching element serving to lock the at least one plug-in end relative to the receptacle, the at least one latching element transversally adjustable to the direction of insertion between a latching position and a release position; and
a release sleeve surrounding a sleeve axis and extending parallel to the direction of insertion, the release sleeve having a gripping area, preferably surrounding the sleeve axis, with a shell expanding radially toward one axial end of the gripping area, the release sleeve configured to actuate the latching element from the latching position to the release position by shifting in an opposite direction to the direction of insertion relative to the at least one latching element.

2. The connector housing according to claim 1, wherein a surface of the shell of the gripping area (30) conically expands radially in the direction of an end of the gripping area opposite the at least one plug-in end (26).

3. The connector housing according to claim 2, wherein an outer shell surface of the gripping area has the shape of a conical frustum shell of a cone, at least in some sections, with an opening angle in the range of about 15° to about 80°.

4. The connector housing according to claim 3, wherein the opening angle is in the range of about 25° to about 55°.

5. The connector housing according to claim 4, wherein the opening angle is in the range of about 30° to about 45°.

6. The connector housing according to claim 1, wherein a ratio of a largest outer diameter D of the gripping area (30) to a smallest outer diameter d of the gripping area (30) is about 1.1 or more.

7. The connector housing according to claim 6, wherein the ratio D/d is about 1.15 or more.

8. The connector housing according to claim 6, wherein the ratio D/d is about 1.5 or less.

9. The connector housing according to claim 8, wherein the ratio D/d is about 1.25 or less.

10. The connector housing according to claim 1, wherein the gripping area transitions into a frontal sleeve area extending approximately vertically to the sleeve axis of the release sleeve.

11. The connector housing according to claim 10, further comprises a rounded transition area located between the gripping area and the frontal sleeve area.

12. The connector housing according to claim 1, further comprises at least one recess provided in a surface of the shell of the release sleeve and dimensioned to accept at least one latching element in the lock-in position.

13. The connector housing according to claim 12, wherein the at least one latching element includes a sliding area rising in a ramp-like manner in a direction opposite to the direction of insertion relative to the sleeve axis.

14. The connector housing according to claim 1, further comprises a pre-tensioning mechanism pushing the at least one latching element into the latching position.

15. The connector housing according to claim 1, wherein the at least one plug-in part includes an internal sleeve accommodated at least partially in the release sleeve.

16. The connector housing according to claim 15, wherein the at least one latching element is formed in one piece with the internal sleeve.

17. The connector housing according to claim 1, wherein the release sleeve is configured to limit movement in a direction parallel to the direction of insertion (P).

18. The connector housing according to claim 1, wherein a surface of the shell of the release sleeve on a side of the gripping area facing the plug-in end, at least in some areas, forms a circular cylinder shell area.

19. The connector housing according to claim 18, wherein the circular cylinder shell area includes at least one trough-like depression.

20. A connector system, comprising:
a socket having a receptacle; and
a connector having at least one plug-in part and a release sleeve and configured to selectively couple to the receptacle, the at least one plug-in part having at least one end and at least one latch, the at least one end being configured to insert into the receptacle in an insertion direction and upon insertion the at least one latch serving to lock the at least one end relative to the receptacle, the at least one latch being transversally adjustable between a latching position and a release position, the release sleeve surrounding a sleeve axis and extending parallel to the insertion direction, the release sleeve having a gripping area, preferably surrounding the sleeve axis, with a shell extending radially toward one axial end of the gripping area, the release sleeve configured to actuate the latching element from the latching position to the release position by shifting in an opposite direction to the direction of insertion relative to the at least one latching element.
